(19) United States
(12) Patent Application Publication
(10) Pub. No.: US 2018/0170450 A1
(43) Pub. Date: Jun. 21, 2018

(54) BEAD STRUCTURE FOR NON-PRESSURE MARK WELDING

(71) Applicants: Hyundai Motor Company, Seoul (KR); Kia Motors Corporation, Seoul (KR)

(72) Inventor: Do Woon CHO, Whasung-Si (KR)

(73) Assignees: Hyundai Motor Company, Seoul (KR); Kia Motors Corporation, Seoul (KR)

(21) Appl. No.: 15/610,411

(22) Filed: May 31, 2017

(30) Foreign Application Priority Data
Dec. 16, 2016 (KR) 10-2016-0172965

(51) Int. Cl. B62D 27/02; B23K 9/025

(52) U.S. Cl. CPC B62D 27/02; B23K 9/025

(57) ABSTRACT

A bead structure for non-pressure mark welding, which is applied to panels for joining a plurality of overlapped panels through projection welding may include a plurality of beads which protrude in the same direction toward an upper portion by pressing the panel disposed in a lower portion among the overlapped panels, and when center points of the beads are connected by a straight line, the beads are disposed to be distanced from each other at a predetermined to form a triangle.

### CROSS-REFERENCE TO RELATED APPLICATION

The present application claims priority to and the benefit of Korean Patent Application No. 10-2016-0172965 filed on Dec. 16, 2016, the entire contents of which are incorporated herein by reference.

### BACKGROUND OF THE INVENTION

### Field of the Invention

The present invention relates to a bead structure for non-pressure mark welding, and more particularly, to a bead structure for non-pressure mark welding, which improves an external quality and merchantability by minimizing a pressure mark generated in a panel during projection welding.

### Description of Related Art

In general, during a manufacturing process of a vehicle, various structure components including a vehicle body panel molded by a press, and the like are joined by a method such as welding, or the like to complete an integrated vehicle body.

In respect to the completed vehicle body, painting and anti-rust operations are performed throughout the surface of each component and components of a power train system, suspension, steering, and braking devices are assembled. Thereafter, an assembly process of assembling a door, a trunk lid, a hood, and the like is performed.

Meanwhile, as a method that joins two vehicle body panels in a vehicle body assembling process, in joining vehicle body components such as a roof, a pillar, side panels, and flanges of the door, spot welding is generally used.

The spot welding as a method that welds the panels by electric resistance while applying pressure force (welding force) to the surface of the vehicle body panel is generally achieved by a spot welding device installed at a front end of an arm of a robot.

However, the spot welding device presses and heats the surface of the vehicle body panel during a welding operation, and as a result, a pressure mark is generated. The pressure mark degrades an exterior quality of the vehicle body panel.

Meanwhile, in recent years, projection welding has been used, which performs electric-resistance welding by pressing projections of an upper panel and a lower panel after manufacturing the projections on the panels.

The projection welding is resistance welding that instantaneously melts a local portion with large current within a short time and presses the panel with low welding force.

However, the pressure mark generated on the panel due to the conventional spot welding or projection welding operation is not removed even after the painting operation, and as a result, there is a disadvantage that a sensitive quality of a completion vehicle deteriorates.

In order to complement such a disadvantage, laser brazing welding is performed or a separate cover is provided, but there is also a disadvantage that manufacturing cost increased due to an increase in cost.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a bead structure for non-pressure mark welding, which minimizes a pressure mark generated on a panel by joining a plurality of panels through a plurality of setting beads during a projection welding operation for joining the plurality of panels to each other to improve external merchantability.

Various aspects of the present invention are directed to providing a bead structure for non-pressure mark welding, which is applied to panels for joining a plurality of overlapped panels through projection welding, including a plurality of beads which protrude in the same direction toward an upper portion by pressing the panel disposed in a lower portion among the overlapped panels, wherein when center points of the beads are connected by a straight line, the beads are disposed to be distanced from each other at a predetermined to form a triangle.

Each of the beads may include a protrusion which protrudes toward the upper portion based on the top portion of the panel, and a groove which is formed to be concave toward the protrusion based on the bottom of the panel to correspond to the protrusion.

The protrusion may include a protruded plane formed by a plane horizontally to the top portion of the panel, and a first inclined plane connecting the top portion of the panel and the protruded plane.

The groove may include a groove plane formed by a plane horizontally to the protruded plane in the lower portion of the protruded plane, and a second inclined plane connecting the bottom of the panel and the groove plane to correspond to the first inclined plane.

A diameter of the protruded plane may be set within the range of 1.5 to 2.0 mm.

Inclination angles of the first inclined plane and the third inclined plane may be set within the range of 55° to 65° based on the top portion of the panel.

A part between the first inclined plane and the protruded plane and a part between the first inclined plane and the top portion of the panel are formed by curved planes, a part between the second inclined plane and the groove plane and a part between the second inclined plane and the bottom of the panel are formed by the curved planes, and a curvature radius of both curved planes of the first inclined plane may be formed to be larger than the curvature radius of both curved planes of the second inclined plane.

The diameter of an external periphery of each of the beads may be set within the range of 2.0 to 2.5 mm.

A length between the center points of the adjacent beads among the plurality of beads may be set within the range of 3.5 to 4.5 mm.

A distance between outermost peripheries of the adjacent beads among the plurality of beads may be set within the range of 6 to 9 mm.

Various aspects of the present invention are directed to providing a bead structure for non-pressure mark welding, which is applied to panels for joining a plurality of overlapped panels through projection welding, including a plurality of beads which protrude to upper and lower portions by pressing the panel disposed at the center among the plurality of overlapped panels and are disposed to be distanced from each other in a circumferential direction, wherein the beads include a plurality of embossing beads which protrude toward the upper portion and a plurality of intaglio beads which protrude toward the lower portion, and the embossing beads and the intaglio beads are disposed to cross each other in the circumferential direction.

When center points of the embossing beads are connected by a straight line, the beads are distanced from each other at a predetermined to form a triangle, and when the center points of the intaglio beads are connected by the straight line, the intaglio beads may be distanced from each other at a predetermined to form the triangle.

A length between the center points of the embossing beads or the length between the center points of the intaglio beads may be set within the range of 5 to 5.5 mm.

A diameter of a circle connecting outermost peripheries of the embossing beads and the intaglio beads is set within the range of 8.0 to 9.0 mm.

Various aspects of the present invention are directed to providing a bead structure for non-pressure mark welding, which is applied to panels for joining a plurality of overlapped panels through projection welding, including: a plurality of straight-line type beads which protrude toward the panel disposed in an upper portion by pressing the panel disposed in a lower portion among the plurality of panels, which are formed in line.

A length of the straight-line type bead may be set within the range of 4 to 6 mm.

A width length of the straight-line type bead may be set within the range of 1.3 to 1.5 mm.

A pair of straight-line type beads may be configured, and a distance between the straight-line type beads based on a width direction may be within the range of 3 to 5 mm.

According to an exemplary embodiment of the present invention, when a bead structure for non-pressure mark welding is applied, during a projection welding operation for joining a plurality of panels to each other, the plurality of panels is coupled to the panels disposed in a lower portion through a plurality of beads which protrude toward an upper portion to minimize a pressure mark generated in the panel, improving external merchantability.

Further, when three panels are welded to each other, embossing beads and intaglio beads are disposed in a panel disposed at the center to cross each other in a circumference direction to improve a welding quality while minimizing the pressure mark.

Besides, an effect which can be obtained or predicted by the exemplary embodiment of the present invention is directly or implicitly included in detailed description of the exemplary embodiment of the present invention. That is, various effects predicted according to the exemplary embodiment of the present invention will be included in the detailed description to be described below.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a diagram illustrating a bead structure for non-pressure mark welding according to an exemplary embodiment of the present invention.

FIG. 2 is a cross-sectional view taken along line a-a of FIG. 1.

FIG. 3 is a diagram illustrating a bead structure for non-pressure mark welding according to another exemplary embodiment of the present invention.

FIG. 4 is a cross-sectional view taken along line b-b of FIG. 3.

FIG. 5 is a diagram illustrating a bead structure for non-pressure mark welding according to yet another exemplary embodiment of the present invention.

FIG. 6 is a cross-sectional view taken along line d-d of FIG. 5.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is intended to cover not only the exemplary embodiments, but also various alternatives, modifications, equivalents and other embodiments, which may be included within the spirit and scope of the invention as defined by the appended claims.

A bead structure for non-pressure mark welding according to exemplary embodiments of the present invention is applied to minimize a pressure mark which may be generated in a panel 1 when a plurality of panels 1 is coupled to each other through projection welding.

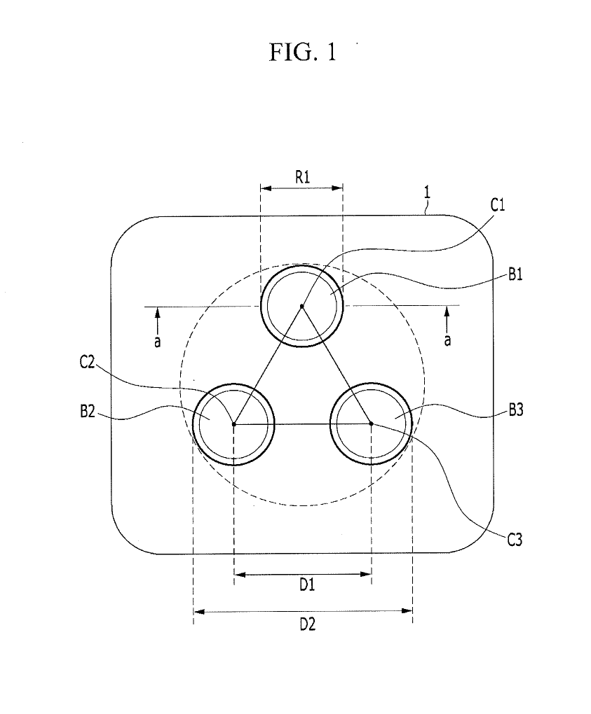

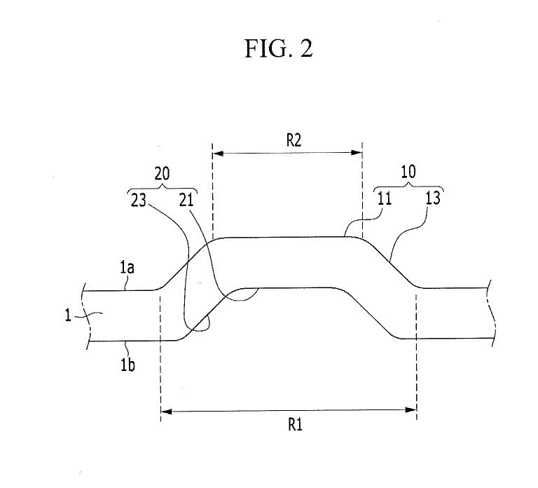

FIG. 1 is a diagram illustrating a bead structure for non-pressure mark welding according to an exemplary embodiment of the present invention and FIG. 2 is a cross-sectional view taken along line a-a of FIG. 1.

Referring to FIG. 1 and FIG. 2, the bead structure according to the exemplary embodiment of the present invention is applied to the panel 1 to join the plurality of panels 1 which overlap with each other. In the exemplary embodiment of the present invention, the bead structure may be applied to the case where two panels 1 disposed in upper and lower portions are coupled to each other.

Herein, among the overlapped panels 1, the panel disposed in the lower portion includes a plurality of beads which protrudes in the same direction toward the upper portion by pressing the panel 1.

In the exemplary embodiment, the beads include the first, second and third beads B1, B2, and B3.

When the respective center points C1, C2, and C3 of the first, second and third beads B1, B2, and B3 are connected to each other by a straight line, the first, second and third beads B1, B2, and B3 are disposed to be distanced from each other at a set angle.

Diameters R1 of external peripheries of the first, second and third beads B1, B2, and B3 connected to the top portion of the panel 1 may be set within the range of 2.0 to 2.5 mm.

Further, among the first, second and third beads B1, B2, and B3, a length D1 among the respective center points C1, C2, and C3 of the adjacent first, second and third beads B1, B2, and B3 may be set within the range of 3.5 to 4.5 mm.

Herein, the length D1 among the center points may be set as, for example, a length between the center point C1 of the first bead B1 and the center point C2 of the second bead B2, between the center point C1 of the first bead B1 and the center point C3 of the third bead B3, or between the center point C2 of the second bead B2 and the center point C3 of the third bead B3.

In addition, among the first, second and third beads B1, B2, and B3, a distance D2 among outermost peripheries of the respective adjacent beads may be set within the range of 6 to 9 mm.

That is, the distance D2 among the outermost peripheries may be set as a length between the outermost periphery of the first bead B1 and the outermost periphery of the second bead B2, between the outermost periphery of the first bead B1 and the outermost periphery of the third bead B3, or between the outermost periphery of the second bead B2 and the outermost periphery of the third bead B3.

As a result, the first, second and third beads B1, B2, and B3 may be disposed adjacent to each other and straight lines connecting the respective center points C1, C2, and C3 may be formed in a regular triangular shape.

Shapes of the first, second and third beads B1, B2, and B3 configured as above will be described below in more detail.

Each of the first, second and third beads B1, B2, and B3 includes a protrusion 10 and a groove 20.

First, the protrusion 10 protrudes upward based on a top portion 1a of the panel 1.

The protrusion 10 includes a protruded plane 11 formed as a plane horizontal to the top portion 1a of the panel 1 and a first inclined plane 13 connecting the top portion 1a of the panel 1 and the protruded plane 11.

Herein, a diameter R2 of the protruded plane 11 may be set within the range of 1.5 to 2.0 mm.

In addition, an inclination angle of the first inclined plane 13 may be set within the range of 55° to 65°.

In the exemplary embodiment, the groove 20 is formed to concave toward the protrusion 10 based on a bottom 1b of the panel 1 to correspond to the protrusion 10.

The groove 20 includes a groove plane 21 formed by a plane horizontal to the protruded plane 11 in the lower portion of the protruded plane 11 and a second inclined plane 23 connecting the bottom 1b of the panel 1 and the groove plane 21 to correspond to the first inclined plane 13.

The inclination angle of the second inclined plane 23 may be set within the range of 55.5° to 60.5° similarly to the first inclined plane 13.

Meanwhile, a part between the first inclined plane 13 and the protruded plane 11 and a part between the first inclined plane 13 and the top portion 1a of the panel 1 are formed by a curved plane.

Further, a part between the second inclined plane 23 and the groove plane 21 and a part between the second inclined plane 21 and the bottom 1b of the panel 1 are formed by the curved plane.

Herein, a curvature radius of both curved planes of the first inclined plane 13 may be formed to be larger than a curvature radius of both curved planes of the second inclined plane 23.

That is, the curvature radius of both curved planes of the first inclined plane 13 may be set within the range of 0.4 to 0.6 mm and the curvature radius of both curved planes of the second inclined plane 23 may be set within the range of 0.2 to 0.4 mm.

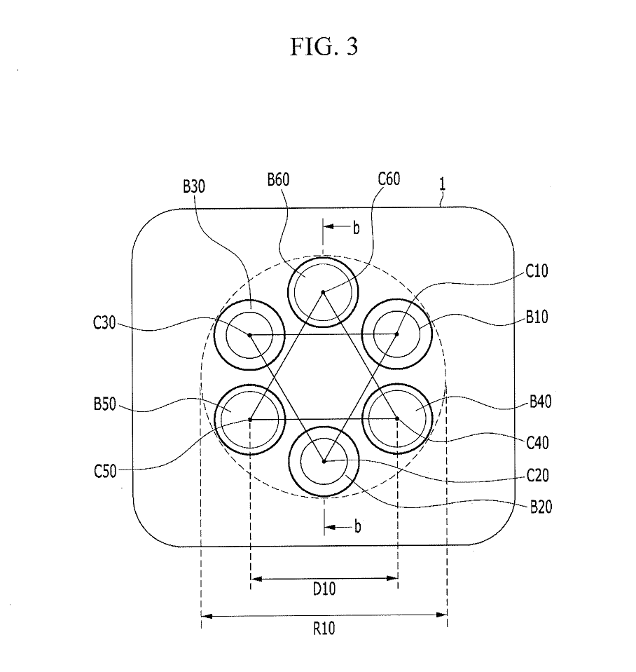

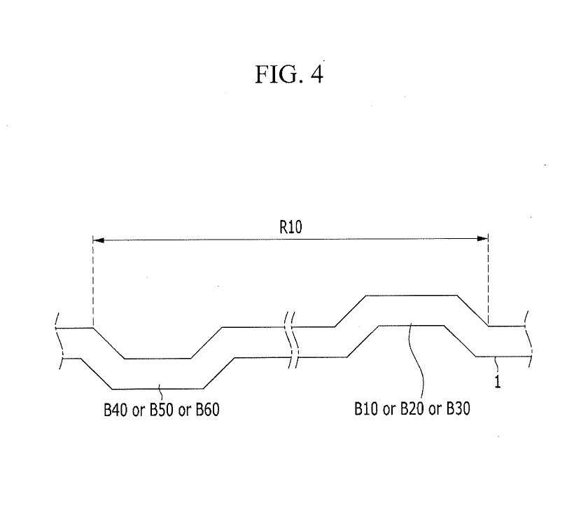

FIG. 3 is a diagram illustrating a bead structure for non-pressure mark welding according to another exemplary embodiment of the present invention and FIG. 4 is a cross-sectional view taken along line b-b of FIG. 3.

Referring to FIG. 3 and FIG. 4, the bead structure according to another exemplary embodiment of the present invention is applied to the panels 1 to join three overlapped panels 1. In another exemplary embodiment of the present invention, the bead structure may be applied to the case where three overlapped panels 1 are coupled to each other.

Herein, among three overlapped panels 1, the panel 1 disposed at the center protrudes to each of the upper portion and the lower portion by pressing the panel 1 and includes a plurality of beads disposed to be distanced from each other in a circumferential direction.

In the exemplary embodiment, the beads include three first, second and third embossing beads B10, B20, and B30 which protrude toward the upper portion and three first, second and third intaglio beads B40, B50, and B60 which protrude toward the lower portion based on the panel 1.

Herein, the first, second and third embossing beads B10, B20, and B30 and the first, second and third intaglio beads B40, B50, and B60 may be disposed to cross each other in the circumferential direction.

That is, when respective center points C10, C20, and C30 of the first, second and third embossing beads B10, B20, and B30 are connected to each other by the straight line, the first, second and third embossing beads B10, B20, and B30 are disposed to be distanced from each other at a predetermined angle to form a triangle.

In addition, when respective center points C40, C50, and C60 of the first, second and third intaglio beads B40, B50, and B60 are connected to each other by the straight line, the first, second and third intaglio beads B40, B50, and B60 are disposed to be distanced from each other at a predetermined angle to form the triangle.

As a result, in the case of the beads, the first intaglio bead B40, the second embossing bead B20, the second intaglio bead B50, the third embossing bead B30, and the third intaglio bead B60 may be sequentially disposed in a clockwise direction based on the first embossing bead B10.

In addition, a length D10 among the center points C10, C20, and C30 of the embossing beads B10, B20, and B30 or a length D10 among the center points C40, C50, and C60 of the intaglio beads B40, B50, and B60 may be set within the range of 5 to 5.5 mm.

Herein, the length D10 among the center points may be set as a length between the center point C10 of the first embossing bead B10 and the center point C20 of the second embossing bead B20, between the center point C10 of the first embossing bead B10 and the center point C30 of the third embossing bead B30, or between the center point C20 of the second embossing bead B20 and the center point C30 of the third embossing bead B30.

Further, the length D10 among the center points may be set as a length between the center point C40 of the first intaglio bead B40 and the center point C50 of the second intaglio bead B50, between the center point C40 of the first intaglio bead B40 and the center point C60 of the third intaglio bead B60, or between the center point C50 of the second intaglio bead B50 and the center point C60 of the third intaglio bead B60.

In addition, a diameter R10 of a circle connecting the outermost peripheries of the first, second and third embossing beads B10, B20, and B30 and the first, second and third intaglio beads B40, B50, and B60 may be set within the range of 8.0 to 9.0 mm.

That is, the first, second and third embossing beads B10, B20, and B30 and the first, second and third intaglio beads B40, B50, and B60 are distanced from each other at a predetermined angle in the circumferential direction in the circle in which the diameter R10 is formed within the range of 8.0 to 9.0 mm.

As described above, detailed shapes of the first, second and third embossing beads B10, B20, and B30 and first, second and third intaglio beads B40, B50, and B60 may be formed to be similar to the detailed shapes of the beads according to the exemplary embodiment.

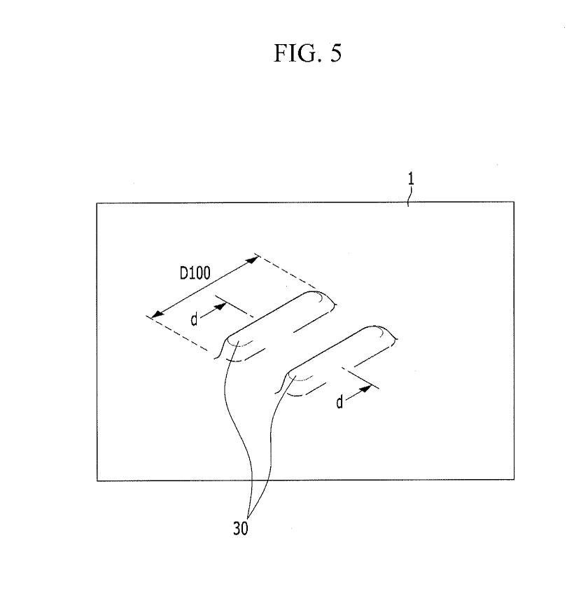

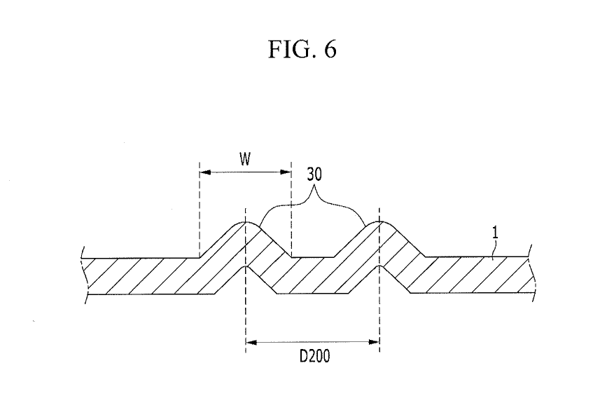

FIG. 5 is a diagram illustrating a bead structure for non-pressure mark welding according to yet another exemplary embodiment of the present invention and FIG. 6 is a cross-sectional view taken along line d-d of FIG. 5.

Referring to FIG. 5 and FIG. 6, the bead structure according to yet another exemplary embodiment of the present invention is applied to the panels 1 to join three overlapped panels 1. In the exemplary embodiment of the present invention, the bead structure may be applied to the case where two panels 1 disposed in the upper and lower portions are coupled to each other.

Herein, among three overlapped panels 1, in the panel 1 disposed in the lower portion, a straight-line type bead 30 which protrude in the same direction toward the upper portion are formed in line by pressing the panel 1.

A length D100 of the straight-line type bead 30 is set within the range of 4 to 6 mm.

A width length W of the straight-line type bead 30 may be set within the range of 1.3 to 1.5 mm.

That is, in yet another exemplary embodiment of the present invention, a pair of straight-line type beads 30 may be provided and a distance D200 among the straight-line type beads 30 may be set within the range of 3 to 5 mm based on a width direction.

Therefore, when the bead structure according to the exemplary embodiments of the present invention is applied, the plurality of panels 1 are coupled to the panel 1 disposed in the lower portion through the plurality of beads which protrude toward the upper portion during a projection welding operation for joining the plurality of panels 1 to each other to minimize the pressure mark generated on the panel, improving external merchantability.

Further, when three panels 1 are welded to each other, the embossing beads B10, B20, and B30 and the intaglio beads B40, B50, and B60 are disposed in the panel 1 disposed at the center to cross each other in the circumferential direction, respectively, a welding quality may be improved while minimizing the pressure mark.

For convenience in explanation and accurate definition in the appended claims, the terms “upper”, “lower”, “internal”, “outer”, “up”, “down”, “upper”, “lower”, “upwards”, “downwards”, “front”, “rear”, “back”, “inside”, “outside”, “inwardly”, “outwardly”, “internal”, “external”, “internal”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described to explain certain principles of the invention and their practical application, to enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A bead structure for non-pressure mark welding, which is applied to panels for joining a plurality of overlapped panels through projection welding, comprising:
a plurality of beads which protrude in the same direction toward an upper portion by pressing a panel disposed in a lower portion among the overlapped panels,
wherein when center points of the beads are connected by a straight line, the beads are disposed to be distanced from each other at a predetermined angle to form a triangle.

2. The bead structure of claim 1, wherein each of the beads includes:
a protrusion which protrudes toward the upper portion based on a top portion of the panel, and
a groove which is formed to be concave toward the protrusion based on the bottom of the panel to correspond to the protrusion.

3. The bead structure of claim 2, wherein the protrusion includes:
a protruded plane formed by a plane horizontally to the top portion of the panel, and
a first inclined plane connecting the top portion of the panel and the protruded plane.

4. The bead structure of claim 3, wherein the groove includes:
a groove plane formed by a plane horizontally to the protruded plane in the lower portion of the protruded plane, and
a second inclined plane connecting a bottom of the panel and the groove plane to correspond to the first inclined plane.

5. The bead structure of claim 4, wherein a diameter of the protruded plane is set within a range of 1.5 to 2.0 mm.

6. The bead structure of claim 4, wherein inclination angles of the first inclined plane and the third inclined plane are set within a range of 55° to 65° based on the top portion of the panel.

7. The bead structure of claim 4, wherein
a part between the first inclined plane and the protruded plane and a part between the first inclined plane and the top portion of the panel are formed by curved planes,
a part between the second inclined plane and the groove plane and a part between the second inclined plane and the bottom of the panel are formed by the curved planes, and
a curvature radius of both curved planes of the first inclined plane is formed to be larger than a curvature radius of both curved planes of the second inclined plane.

8. The bead structure of claim 1, wherein
a diameter of an external periphery of each of the beads is set within a range of 2.0 to 2.5 mm.

9. The bead structure of claim 1, wherein a length between the center points of adjacent beads among the plurality of beads is set within a range of 3.5 to 4.5 mm.

10. The bead structure of claim 1, wherein a distance between outermost peripheries of adjacent beads among the plurality of beads is set within the range of 6 to 9 mm.

11. A bead structure for non-pressure mark welding, which is applied to panels for joining a plurality of overlapped panels through projection welding, comprising:
a plurality of beads which protrude to upper and lower portions by pressing a panel disposed at the center among the plurality of overlapped panels and are disposed to be distanced from each other in a circumferential direction thereof,
wherein the beads include a plurality of embossing beads which protrude toward the upper portion and a plurality of intaglio beads which protrude toward the lower portion, and the embossing beads and the intaglio beads are disposed to cross each other in the circumferential direction.

12. The bead structure of claim 11, wherein
when center points of the embossing beads are connected by a straight line, the beads are distanced from each other at a predetermined angle to form a triangle, and
when center points of the intaglio beads are connected by the straight line, the intaglio beads are distanced from each other at a predetermined angle to form the triangle.

13. The bead structure of claim 11, wherein a length between the center points of the embossing beads or the length between the center points of the intaglio beads is set within a range of 5 to 5.5 mm.

14. The bead structure of claim 11, wherein a diameter of a circle connecting outermost peripheries of the embossing beads and the intaglio beads is set within a range of 8.0 to 9.0 mm.

15. A bead structure for non-pressure mark welding, which is applied to panels for joining a plurality of overlapped panels through projection welding, comprising:
a plurality of straight-line type beads which protrude toward a panel disposed in an upper portion by pressing the panel disposed in a lower portion among the plurality of panels, which are formed in line.

16. The bead structure of claim 15, wherein a length of the straight-line type bead is set within a range of 4 to 6 mm.

17. The bead structure of claim 15, wherein a width length of the straight-line type bead is set within a range of 1.3 to 1.5 mm.

18. The bead structure of claim 15, wherein a pair of straight-line type beads are configured, and a distance between the straight-line type beads based on a width direction thereof is within a range of 3 to 5 mm.
